(19) United States
(12) Patent Application Publication
(10) Pub. No.: US 2008/0124456 A1
(43) Pub. Date: May 29, 2008

(54) Inkjet ink and method for forming cured film using the same

(75) Inventors: Hiroyuki Satou, Ichihara-shi (JP); Hisanobu Minamisawa, Ichihara-shi (JP)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CHISSO Corporation

(21) Appl. No.: 11/987,099

(22) Filed: Nov. 27, 2007

(30) Foreign Application Priority Data
Nov. 28, 2006 (JP) 2006-319509

(51) Int. Cl. B05D 5/12; C08F 2/50; C08G 69/26; C08G 77/04; C08J 3/28

(52) U.S. Cl. 427/99.4; 522/149; 522/36; 528/26; 528/332; 528/353

(57) ABSTRACT

The invention provides an inkjet ink including a compound (A) obtained by polymerizing an acid anhydride group-containing compound (a1), an amino-containing compound (a2), and a hydroxy compound (a3), and provides a method for manufacturing this inkjet ink.

### CROSS REFERENCE TO RELATED APPLICATIONS

This application claims priority under 35 U.S.C. §119 to Japanese Patent Application No. JP 2006-319509, filed Nov. 28, 2006, which application is expressly incorporated herein by reference in its entirety.

### BACKGROUND OF THE INVENTION

1. Field of the Invention

The invention relates to an inkjet ink, and more particularly relates to an inkjet ink that is used to manufacture a liquid crystal display element, an electroluminescent display element, a printing wiring board, or the like. The invention further relates to a method for manufacturing the inkjet ink, to an ink coating method in which the inkjet ink is used, to a cured film obtained with the inkjet ink, to a method for forming the cured film, and to an electronic circuit board on which the cured film is formed.

2. Related Art

Patterned cured films are used for many parts of a liquid crystal display element, such as spacers, insulating films, and protective films, and numerous photocurable compositions have been proposed for such applications before now (see Japanese Laid-Open Patent Application 2004-287232, for example). The common method for using a photocurable composition to produce a patterned cured film is photolithography, in which ultraviolet rays is directed through a mask having the desired pattern, and the portion not irradiated with the UV rays is removed by developing.

This method, however, needs a dedicated production line equipped with an exposure device, developing device, etc., which requires considerable financial investment in equipment.

Under this situation, there have been proposals in recent years for inkjet methods, which are advantageous in that they entail less investment in equipment, do not involve the use of a developing solution, and use materials more efficiently, and for compositions to be used in these methods (see Japanese Laid-Open Patent Application 2003-302642, for example).

However, when these compositions are patterned by inkjet method, the droplets discharged from the inkjet head spread out on the substrate after landing, and this lowers resolution and makes it difficult to form a very fine pattern.

### SUMMARY OF THE INVENTION

It has been observed that an inkjet ink including a compound having structural units expressed by the following Formulas (1) and (2) spreads out less upon landing, and completed the invention on the basis of this knowledge. The invention provides the following inkjet ink, a method for manufacturing the inkjet ink, an ink coating method in which the inkjet ink is used, a cured film obtained with the inkjet ink, a method for forming the cured film, and an electronic circuit board or other substrate on which the cured film is formed.

[1] An inkjet ink including a compound (A) having structural units expressed by the following General Formulas (1) and (2):

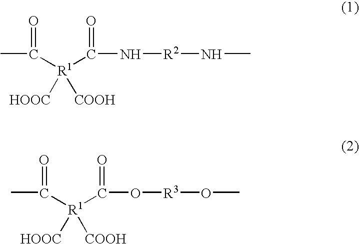

wherein Formulas (1) and (2), R¹, R², and R³ are each independently a C₂ to C₁₀₀ organic group.

[2] The inkjet ink according to item [1], wherein the compound (A) is synthesized using at least an acid anhydride group-containing compound (a1), an amino-containing compound (a2), and a hydroxy compound (a3).

[3] The inkjet ink according to item [2], wherein the acid anhydride group-containing compound (a1) is a tetracarboxylic dianhydride.

[4] The inkjet ink according to item [2], wherein the acid anhydride group-containing compound (a1) is a copolymer of a radical polymerizable monomer having an acid anhydride group and another radical polymerizable monomer.

[5] The inkjet ink according to item [2], wherein the acid anhydride group-containing compound (a1) is one or more compounds selected from the group of styrene-maleic anhydride copolymers, methyl (meth)acrylate-maleic anhydride copolymers, glycidyl (meth)acrylate-maleic anhydride copolymers, 2-hydroxyethyl (meth)acrylate-maleic anhydride copolymers, styrene-itaconic anhydride copolymers, and methyl (meth)acrylate-itaconic anhydride copolymers.

[6] The inkjet ink according to any of items [2] to [5], wherein the amino-containing compound (a2) is one or more compounds selected from the group of 4,4′-diaminodiphenylsulfone, 3,3′-diaminodiphenylsulfone, 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]hexafluoropropane, 2,2′-diaminodiphenylpropane, and diamines expressed by the following Formula (3):

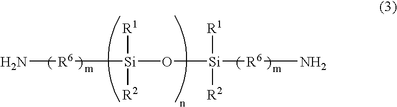

wherein Formula (3), R¹ and R² are each independently a C₁ to C₃ alkyl or phenyl, each R⁶ is independently a methylene, phenylene, or alkyl-substituted phenylene, each m is independently an integer from 1 to 6, and n is an integer from 1 to 100.

[7] The inkjet ink according to any of items [2] to [5], wherein the amino-containing compound (a2) is a diamine expressed by the following Formula (3):

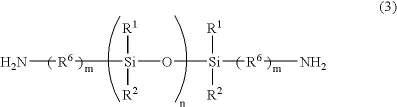

wherein Formula (3), R¹ and R² are each independently a C₁ to C₃ alkyl or phenyl, each R⁶ is independently a methylene, phenylene, or alkyl-substituted phenylene, each m is independently an integer from 1 to 6, and n is an integer from 1 to 100.

[8] The inkjet ink according to any of items [2] to [7], wherein the hydroxy compound (a3) is one or more compounds selected from the group of benzyl alcohol, propylene glycol monomethyl ether, diethylene glycol monomethyl ether, diethylene glycol monoethyl ether, cyclohexanol, ethylene glycol, diethylene glycol, triethylene glycol, polyethylene glycol with a degree of polymerization of 4 to 10, propylene glycol, dipropylene glycol, tripropylene glycol, polypropylene glycol with a degree of polymerization of 4 to 10, ethyl lactate, 1,4-butanediol, trimethylolpropane, pentaerythritol, dipentaerythritol, 1,2-butanediol, 1,4-cyclohexanedimethanol, an ethylene oxide adduct of 2,2-bis(4-hydroxyphenyl)propane, an ethylene oxide adduct of 2,2-bis(4-hydroxyphenyl)sulfone, and compounds expressed by the following General Formula (4):

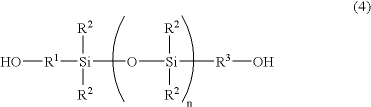

wherein Formula (4), R¹ and R³ are each independently a C₁ to C₂₀ alkyl in which any methylene may be replaced by an oxygen atom, R² is a C₁ to C₅ alkyl, and n is an integer from 1 to 100.

[9] The inkjet ink according to any of items [2] to [6], wherein the hydroxy compound (a3) is a compound obtained by reacting a compound having an oxirane with a compound having a carboxyl.

[10] The inkjet ink according to item [9], wherein the compound having a carboxyl is a (meth)acrylic acid.

[11] The photocurable inkjet ink according to any of items [1] to [10], further includes a double bond compound (B) (compound having one or more double bonds) and a photopolymerization initiator (C).

[12] The photocurable inkjet ink according to item [11], wherein the double bond compound (B) has a (meth)acryloyl group.

[13] The photocurable inkjet ink according to item [11], wherein the double bond compound (B) has one or more groups selected from the group of oxirane, oxetane, and hydroxy.

[14] The photocurable inkjet ink according to item [11], wherein the double bond compound (B) is one or more compounds selected from the group of glycidyl (meth)acrylate, 2-hydroxyethyl(meth)acrylate, 2-hydroxypropyl(meth)acrylate, 4-hydroxybutyl(meth)acrylate, 4-hydroxybutyl(meth)acrylate glycidyl ether, 1,4-cyclohexanedimethanol mono(meth)acrylate, 3-ethyl-3-(meth)acryloxymethyloxetane, 2-ethyl-2-(meth)acryloxymethyloxetane, pentaerythritol tri(meth)acrylate, dipentaerythritol penta(meth)acrylate, and isocyanuric acid ethylene oxide-modified di(meth)acrylate.

[15] The photocurable inkjet ink according to any of items [11] to [14], wherein the photopolymerization initiator (C) is one or more compounds selected from the group of compounds expressed by the following Formula (6):

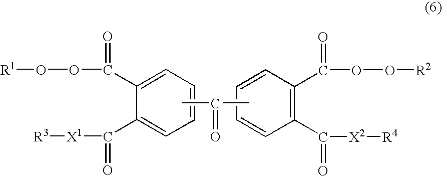

wherein Formula (6), R¹, R², R³ and R⁴ are each independently a C₁ to C₁₃ alkyl, and X¹ and X² are each independently a —O—, —O—O—, or —NH—, compounds expressed by the following Formula (7):

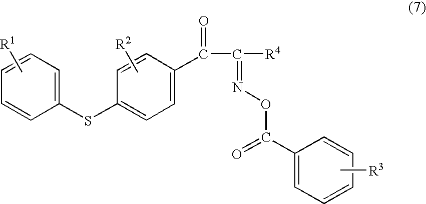

wherein Formula (7), R¹, R², and R³ are each independently a hydrogen or a C₁ to C₅ alkyl, and R⁴ is a C₁ to C₁₅ alkyl, 2-methyl-1-[4-(methylthio)phenyl]-2-morpholinopropan-1-one, and 2-benzyl-2-dimethylamino-1-(4-morpholinophenyl)-butanone-1.

[16] The photocurable inkjet ink according to any of items [11] to [14], wherein the photopolymerization initiator (C) contains one or more compounds selected from the group of compounds expressed by the following Formula (6):

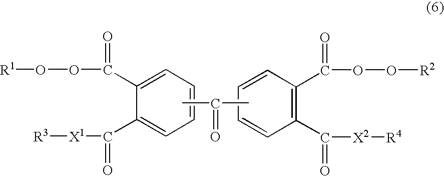

wherein Formula (6), R¹, R², R³ and R⁴ are each independently a C₁ to C₁₃ alkyl, and X¹ and X² are each independently a —O—, —O—O—, or —NH—, compounds expressed by the following Formula (7):

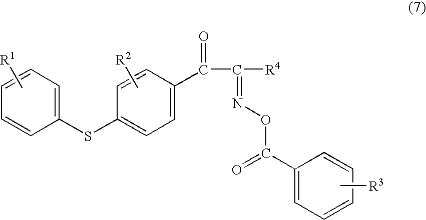

wherein Formula (7), R¹, R², and R³ are each independently a hydrogen or a C₁ to C₅ alkyl, and R⁴ is a C₁ to C₁₅ alkyl), 2-methyl-1-[4-(methylthio)phenyl]-2-morpholinopropan-1-one, and 2-benzyl-2-dimethylamino-1-(4-morpholinophenyl)-butanone-1 in an amount of approximately 20 to approximately 100% with respect to the total weight of the photopolymerization initiator (C).

[17] The photocurable inkjet ink according to any of items [11] to [16], wherein the inkjet ink includes approximately 20 to approximately 1000 weight parts of the double bond compound (B) and approximately 0.5 to approximately 200 weight parts of the photopolymerization initiator (C) per 100 weight parts compound (A).

[18] A method for manufacturing an inkjet ink, including a step of manufacturing a compound (A) by polymerizing:

an acid anhydride group-containing compound (a1) that is one or more compounds selected from the group of styrene-maleic anhydride copolymers, methyl(meth)acrylate-maleic anhydride copolymers, glycidyl(meth)acrylate-maleic anhydride copolymers, 2-hydroxyethyl(meth)acrylate-maleic anhydride copolymers, styrene-itaconic anhydride copolymers, and methyl(meth)acrylate-itaconic anhydride copolymers,

an amino-containing compound (a2) that is one or more compounds selected from the group of 4,4′-diaminodiphenylsulfone, 3,3′-diaminodiphenylsulfone, 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]hexafluoropropane, 2,2′-diaminodiphenylpropane, and diamines expressed by the following Formula (3):

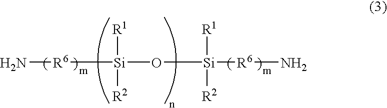

wherein Formula (3), R¹ and R² are each independently a C₁ to C₃ alkyl or phenyl, each R⁶ is independently a methylene, phenylene, or alkyl-substituted phenylene, each m is independently an integer from 1 to 6, and n is an integer from 1 to 100, and

a hydroxy compound (a3) that is one or more compounds selected from the group of ethylene glycol, propylene glycol, 1,4-butanediol, benzyl alcohol, diethylene glycol monoethyl ether, and compounds expressed by the following General Formula (4):

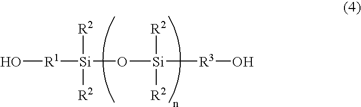

wherein Formula (4), R¹ and R³ are each independently a C₁ to C₂₀ alkyl in which any methylene may be replaced by an oxygen atom, R² is a C₁ to C₅ alkyl, and n is an integer from 1 to 100.

[19] The method for manufacturing an inkjet ink according to item [18], further including a step of mixing the compound (A) with a double bond compound (B) that is one or more compounds selected from the group of glycidyl(meth)acrylate, 2-hydroxyethyl(meth)acrylate, 2-hydroxypropyl(meth)acrylate, 4-hydroxybutyl(meth)acrylate, 4-hydroxybutyl(meth)acrylate glycidyl ether, 1,4-cyclohexanedimethanol mono(meth)acrylate, 3-ethyl-3-(meth)acryloxymethyloxetane, 2-ethyl-2-(meth)acryloxymethyloxetane, pentaerythritol tri(meth)acrylate, dipentaerythritol penta(meth)acrylate, and isocyanuric acid ethylene oxide-modified di(meth)acrylate, and

a photopolymerization initiator (C) that is one or more compounds selected from the group of 2-methyl-1-[4-(methylthio)phenyl]-2-morpholinopropan-1-one and 2-benzyl-2-dimethylamino-1-(4-morpholinophenyl)-butanone-1.

[20] An ink coating method, including the steps of:

applying the inkjet ink according to any of items [1] to [17], or an inkjet ink manufactured by the manufacturing method according to items [18] or [19], by inkjet coating method and then drying to form a coating film; and

forming a cured film by heating this coating film or irradiating it with light.

[21] A method for forming a cured film, wherein a cured film is formed using the inkjet coating method according to item [20].

[22] An electronic circuit board, wherein a cured film is formed on a board using the method for forming a cured film according to item [21].

[23] An electronic component, having the electronic circuit board according to item [22].

[24] An electronic circuit board and display element having the cured film formed in item [21].

In this Specification, the term “(meth)acrylic acid” will be used to refer to both acrylic acid and methacrylic acid.

With an inkjet ink pertaining to a preferred mode of the invention, the ink will spread out less after the landing of the droplets discharged from the inkjet head, which allows a finer pattern to be formed. A cured film obtained with an inkjet ink pertaining to a preferred mode of the invention has high chemical resistance.

A display spacer obtained using an inkjet ink pertaining to a preferred mode of the invention can be very finely patterned, has good chemical resistance, and has less leak light and other such defects, so when this ink is used, very fine liquid crystal panels can be manufactured at a high yield.

### DETAILED DESCRIPTION OF THE INVENTION

1. Inkjet Ink of the Invention

This inkjet ink includes a compound (A) having structural units expressed by the above-mentioned Formulas (1) and (2).

The inkjet ink of the invention can be obtained by mixing or dissolving thermosetting compounds, solvents, various additives, colorants, and so forth in compound (A). There are no particular restrictions on the concentration of compound (A) in the inkjet ink of the invention, but approximately 2 to approximately 60 wt % is preferable, and approximately 3 to approximately 40 wt % is more preferable.

It is preferable for the inkjet ink to have a viscosity of approximately 2 to approximately 500 mPa·s, as measured at 25° C. by E-type viscometer, because the ink discharge characteristics will be better. The discharge temperature is preferably approximately 10 to approximately 120° C. The viscosity of the inkjet ink at the discharge temperature is preferably approximately 2 to approximately 30 mPa·s.

2. Compound (A) of the Invention

Compound (A) has structural units expressed by Formulas (1) and (2). R¹, R², and R³ in Formulas (1) and (2) are each independently a C₂ to C₁₀₀ organic group.

2.1 Method for Manufacturing Compound (A)

There are no particular restrictions on the method for manufacturing the compound (A), but it can be synthesized, for example, by copolymerizing an acid anhydride group-containing compound (a1), an amino-containing compound (a2), and a hydroxy compound (a3).

(1) Acid Anhydride Group-Containing Compound (a1)

There are no particular restrictions on the acid anhydride group-containing compound (a1) as long as it has one or more acid anhydride groups, but the use of a tetracarboxylic dianhydride is preferable because the discharge characteristics of the inkjet ink will be better. Specific examples of tetracarboxylic dianhydrides include the compounds expressed by the following Formulas a1-1 to a1-73.

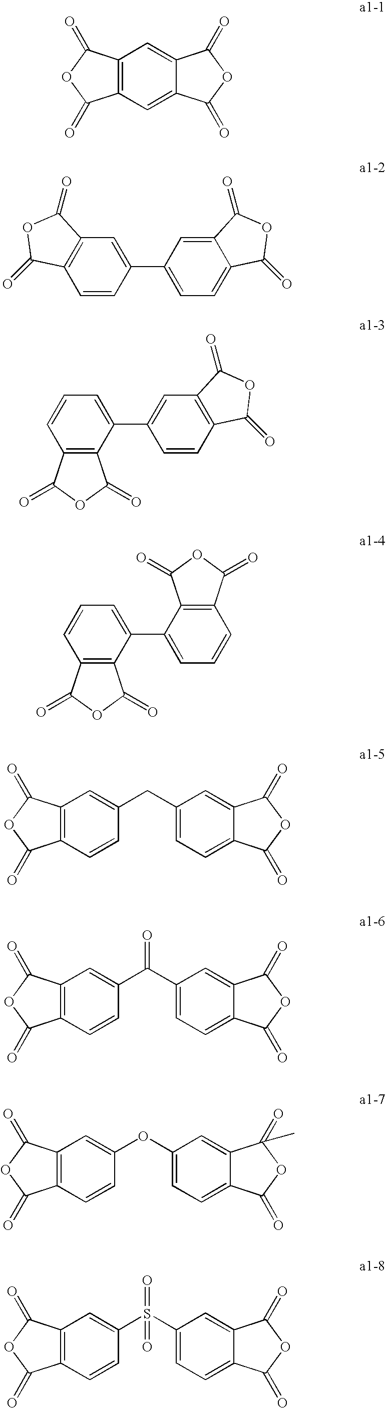

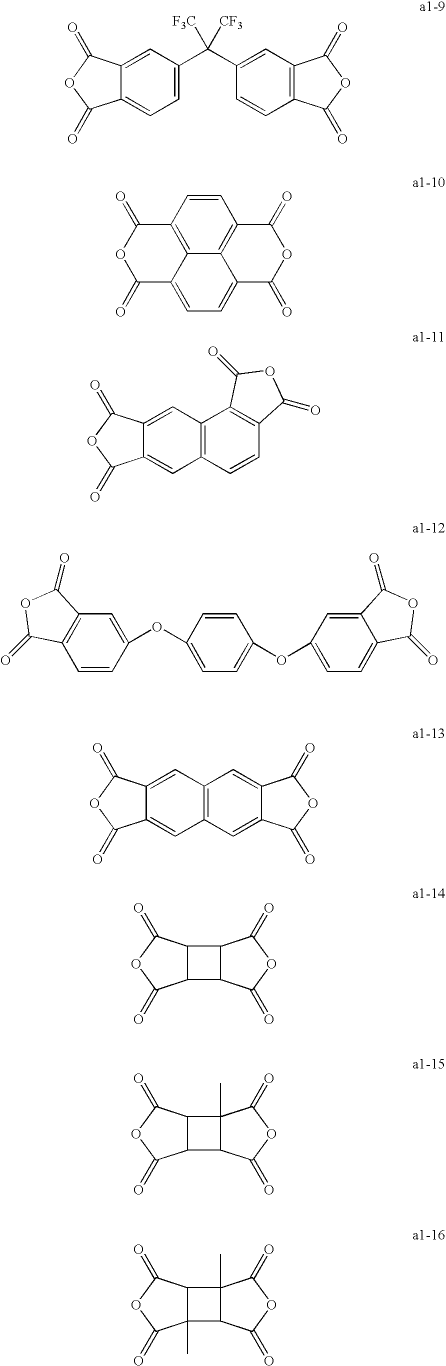

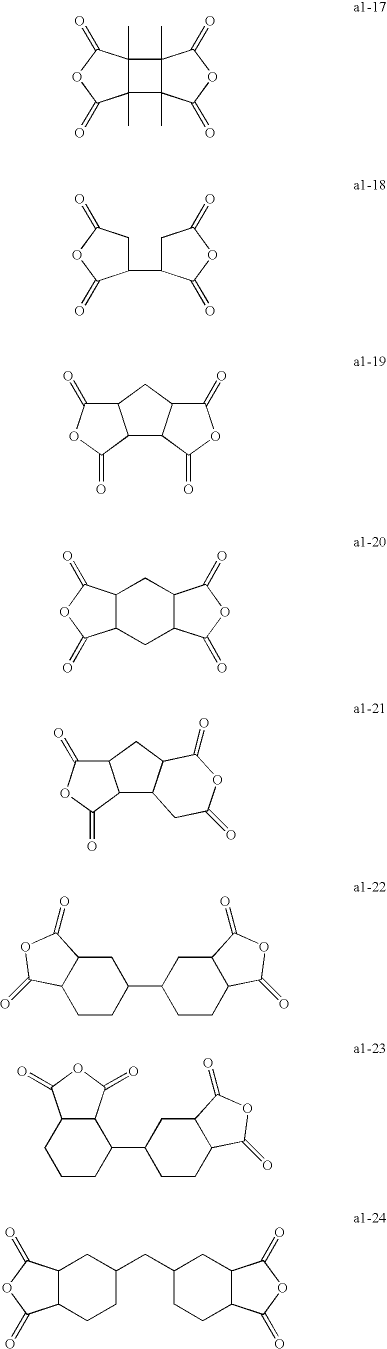

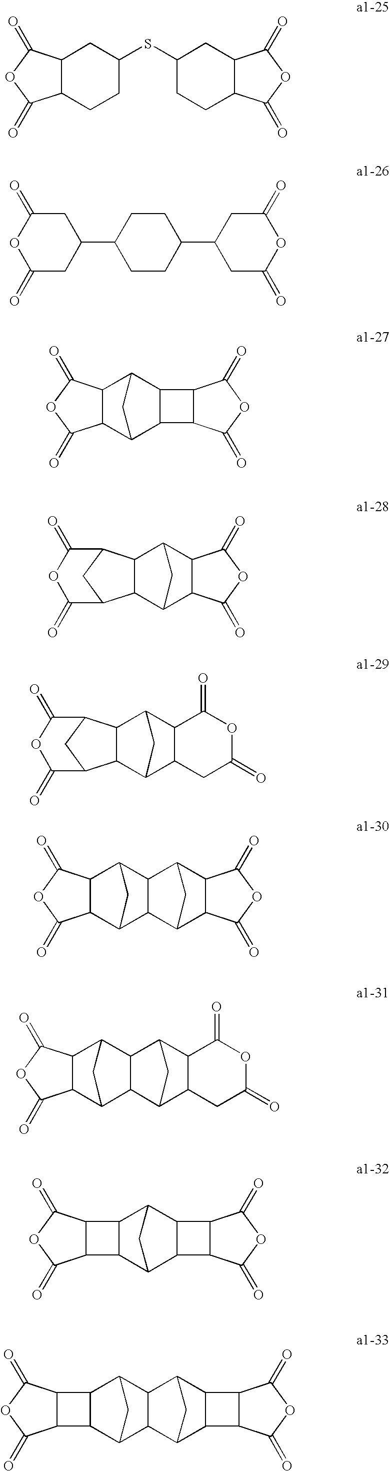

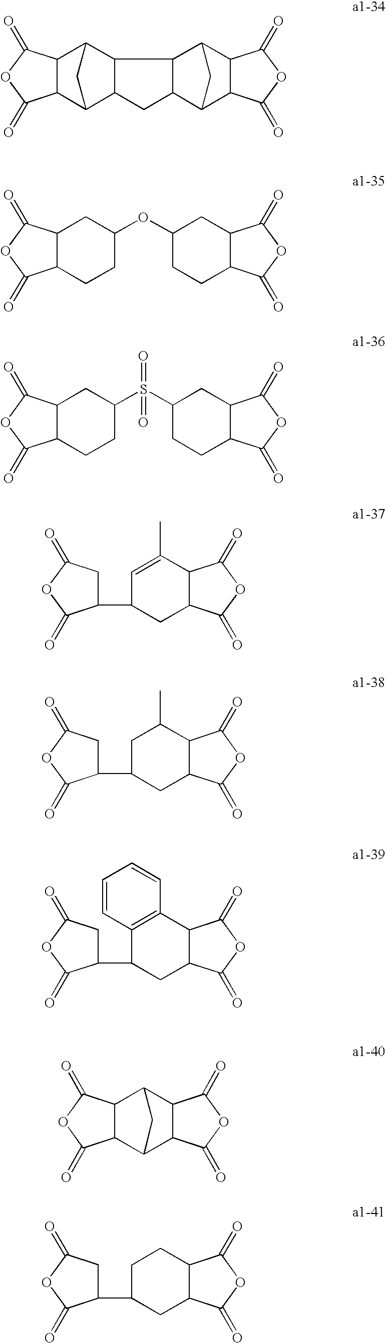

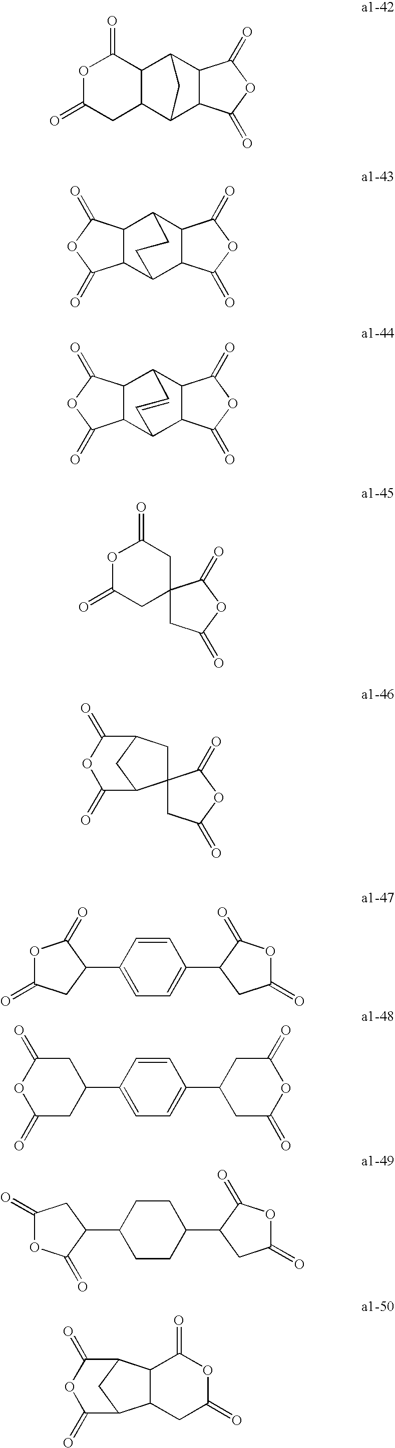

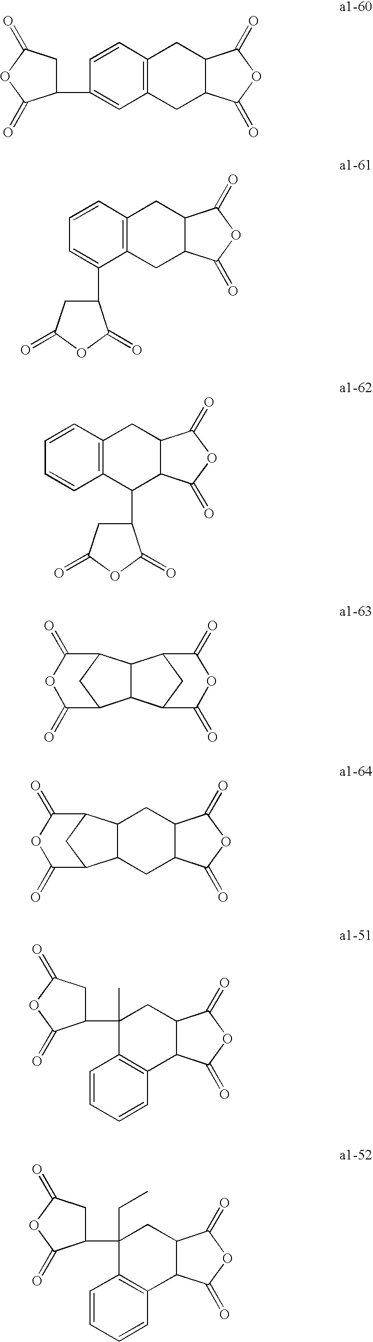

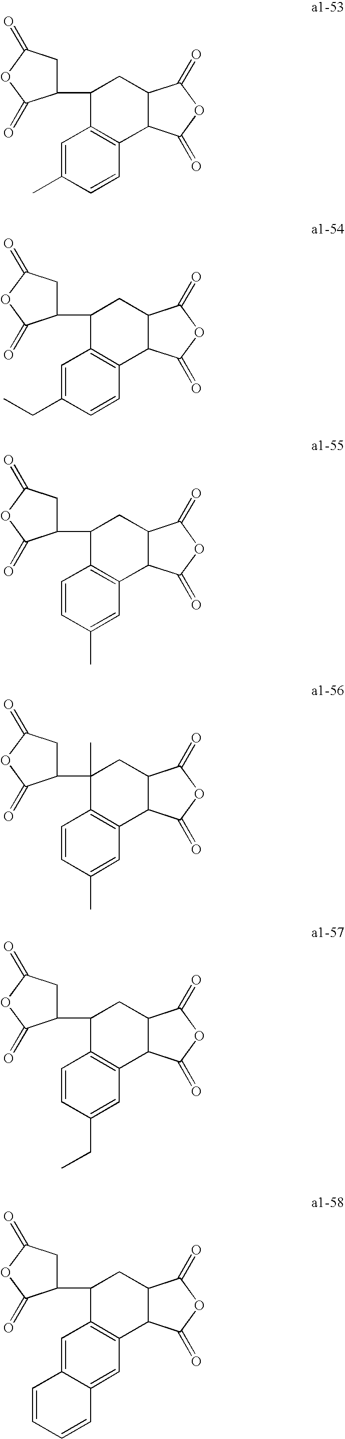

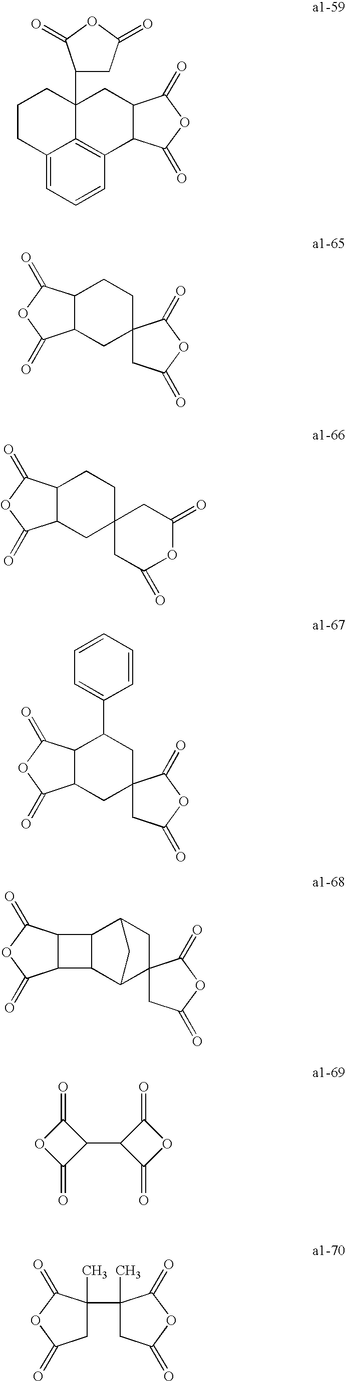

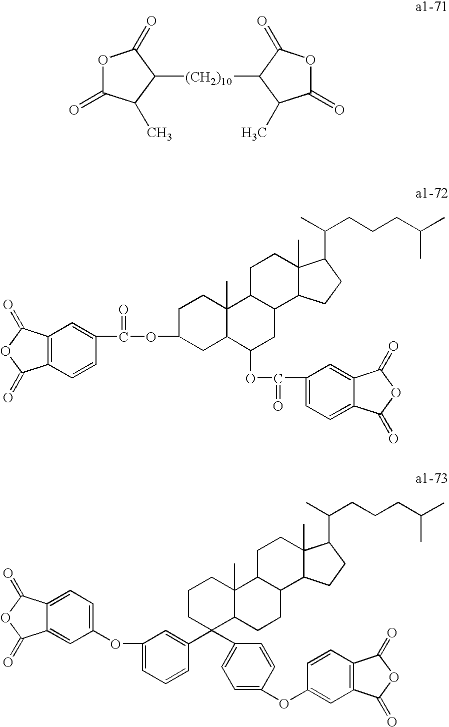

Of the specific examples of tetracarboxylic dianhydrides listed above, it is more preferable to use 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenyl ether tetracarboxylic dianhydride, 2,2′,3,3′-diphenyl ether tetracarboxylic dianhydride, 2,3,3′,4′-diphenyl ether tetracarboxylic dianhydride, 2,2-[bis(3,4-dicarboxyphenyl)]hexafluoropropane dianhydride, ethylene glycol bis(anhydromellitate), cyclobutanetetracarboxylic dianhydride, methylcyclobutanetetracarboxylic dianhydride, cyclopentanetetracarboxylic dianhydride, cyclohexanetetracarboxylic dianhydride, ethanetetracarboxylic dianhydride, and butanetetracarboxylic dianhydride.

The use of a copolymer of a radical polymerizable monomer having an acid anhydride group and another radical polymerizable monomer for the acid anhydride group-containing compound (a1) is preferable because the inkjet ink of the invention will spread out less upon landing. Specific examples of this copolymer include styrene-maleic anhydride copolymers, methyl(meth)acrylate-maleic anhydride copolymers, glycidyl(meth)acrylate-maleic anhydride copolymers, 2-hydroxyethyl(meth)acrylate-maleic anhydride copolymers, styrene-itaconic anhydride copolymers, methyl(meth)acrylate-itaconic anhydride copolymers, and the like. Of these, a styrene-maleic anhydride copolymer is preferred.

The acid anhydride group-containing compound may be a single type of compound, or may be a mixture of two or more different kinds of compound.

(2) Amino-Containing Compound (a2)

There are no particular restrictions on the amino-containing compound (a2) as long as it has one or more aminos, but a diamine is preferred. Specific examples of diamines include 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]propane, 2,2-bis[4-(4-aminophenoxy)phenyl]hexafluoropropane, m-phenylenediaamine, p-phenylenediamine, m-xylylenediaamine, p-xylylenediamine, 2,2′-diaminodiphenylpropane, benzidine, 1,1-bis[4-(4-aminophenoxy)phenyl]cyclohexane, 1,1-bis[4-(4-aminophenoxy)phenyl]-4-methylcyclohexane, bis[4-(4-aminobenzyl)phenyl]methane, 1,1-bis[4-(4-aminobenzyl)phenyl]cyclohexane, 1,1-bis[4-(4-aminobenzyl)phenyl]-4-methylcyclohexane, 1,1-bis[4-(4-aminobenzyl)phenyl]methane, 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 2,2-bis[4-(4-aminophenoxy)phenyl]hexafluoropropane, and diamines expressed by the above-mentioned Formula (3).

Of these, it is preferable to select one or more compounds from among those expressed by Formula (3) and 4,4′-diaminodiphenylsulfone, 3,3′-diaminodiphenylsulfone, 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]hexafluoropropane, and 2,2′-diaminodiphenylpropane.

Furthermore, it is more preferable to use a compound expressed by Formula (3) because there will be less spreading of the ink after landing. In particular, R¹ and R² in Formula (3) are each independently a C₁ to C₃ alkyl or phenyl, and each R⁶ is independently a methylene, phenylene, or alkyl-substituted phenylene. Of these, it is preferable for R¹ and R² both to be a methyl. It is also preferable for R⁶ to be a C₁ to C₆ alkylene, with propylene being especially favorable. m is preferably an integer from 1 to 3, with 1 being better yet. n is preferably an integer from 5 to 50, with an integer from 10 to 20 being better yet. Silaplane FM-3311 (trade name of Chisso) is an example of a diamine in which R¹ and R² are both a methyl, R⁶ is a propylene, m is 1, and n is an integer from 10 to 20 in Formula (3).

Further, the amino-containing compound may be a single type of compound, or a mixture of two or more different compounds.

(3) Hydroxy Compound (a3)

There are no particular restrictions on the hydroxy compound (a3) as long as it has one or more hydroxys, but a compound containing at least one alcoholic hydroxyl group is preferable. Specific examples of compounds having at least one alcoholic hydroxyl group include methanol, ethanol, 1-propanol, 2-propanol, 2-hydroxyethyl(meth)acrylate, 2-hydroxypropyl(meth)acrylate, trimethylolpropane di(meth)acrylate, pentaerythritol tri(meth)acrylate, dipentaerythritol penta(meth)acrylate, allyl alcohol, furfuryl alcohol, tetrahydrofurfuryl alcohol, a caprolactone adduct of tetrahydrofurfuryl alcohol, cyclohexanol, 3-cyclohexene-1-methanol, benzyl alcohol, 1-(2-hydroxyethyl)-2-pyrrolidone, propylene glycol monomethyl ether, diethylene glycol monomethyl ether, diethylene glycol monoethyl ether, cyclohexanol, ethylene glycol, diethylene glycol, triethylene glycol, polyethylene glycol with a degree of polymerization of 4 to 10, propylene glycol, dipropylene glycol, tripropylene glycol, polypropylene glycol with a degree of polymerization of 4 to 10, ethyl lactate, 1,4-butanediol, trimethylolpropane, pentaerythritol, dipentaerythritol, 1,2-butanediol, 1,4-cyclohexanedimethanol, an ethylene oxide adduct of 2,2-bis(4-hydroxyphenyl)propane, an ethylene oxide adduct of 2,2-bis(4-hydroxyphenyl)sulfone, and compounds expressed by the above-mentioned Formula (4).

Of these, it is preferable for the hydroxy compound to be at least one compound selected from among ethylene glycol, propylene glycol, 1,4-butanediol, benzyl alcohol, diethylene glycol monoethyl ether, and compounds expressed by the above-mentioned Formula (4), because this will afford better inkjet ink discharge characteristics.

The hydroxy compound may be a single type of compound, or a mixture of two or more different compounds.

(4) Synthesis of Compound (A)

There are no particular restrictions on the method for synthesizing the compound (A) by reacting an acid anhydride group-containing compound (a1), an amino-containing compound (a2), and a hydroxy compound (a3), but it is preferable to react these compounds in a solution made with a solvent. There are no particular restrictions on the reaction temperature, but it is usually between approximately 10° C. and approximately 120° C. There are no particular restrictions on the reaction time, either, but it is usually between approximately 3 and approximately 24 hours.

The solvent used for the above-mentioned polymerization reaction is preferably one that will dissolve the acid anhydride group-containing compound (a1), the amino-containing compound (a2), the hydroxy compound (a3), and the compound (A) that is produced. Specific examples of such solvents include diethylene glycol dimethyl ether, diethylene glycol methyl ethyl ether, ethyl 3-ethoxypropionate, N,N-dimethylformamide, N-methyl-2-pyrrolidone, and γ-butyrolactone. A mixture of these may also be used.

It is also preferable for the molecular weight of the compound (A) obtained by reacting the acid anhydride group-containing compound (a1), the amino-containing compound (a2), and the hydroxy compound (a3) to be within a specific range, because the inkjet discharge characteristics of the inkjet ink of the invention will be better. In view of this, a compound having one acid anhydride group, a compound having one amino, or the like may be further added to adjust the molecular weight of the compound (A).

Specific examples of compounds having one acid anhydride include maleic anhydride, phthalic anhydride, trimellitic anhydride, and the like. Specific examples of monoamines include aniline, butylamine, benzylamine, 3-aminopropyltrimethoxysilane, 3-aminopropyltriethoxysilane, 3-aminopropylmethyldimethoxysilane, 3-aminopropylmethyldiethoxysilane, 4-aminobutyltrimethoxysilane, 4-aminobutyltriethoxysilane, 4-aminobutylmethyldiethoxysilane, p-aminophenyltrimethoxysilane, p-aminophenyltriethoxysilane, p-aminophenylmethyldimethoxysilane, p-aminophenylmethyldiethoxysilane, m-aminophenyltrimethoxysilane, m-aminophenylmethyldiethoxysilane, and the like.

Either a compound having one acid anhydride group or a compound having one amino is generally used.

The compound (A) obtained by reacting the acid anhydride group-containing compound (a1), the amino-containing compound (a2), and the hydroxy compound (a3) preferably has a weight average molecular weight, as determined by GPC analysis using polystyrene as a reference, between approximately 1,500 and approximately 100,000, because the discharge characteristics of the inkjet ink will be better. It is particularly favorable for the weight average molecular weight to be between approximately 2,000 and approximately 20,000.

In the synthesis of the compound (A) obtained by reacting the acid anhydride group-containing compound (a1), the amino-containing compound (a2), and the hydroxy compound (a3), the amino-containing compound (a2) is preferably reacted in an amount of approximately 5 to approximately 500 weight parts, and more preferably approximately 10 to approximately 300 weight parts, and the hydroxy compound (a3) in an amount of approximately 5 to approximately 500 weight parts, and more preferably approximately 10 to approximately 300 weight parts, per 100 weight parts of the acid anhydride group-containing compound (a1), because the inkjet ink of the invention will spread out less after landing and will adhere better to the substrate.

3. Additives That Can Be Included in the Inkjet Ink of the Invention

The inkjet ink of the invention can further include a double bond compound (B) and a photopolymerization initiator (C).

The inkjet ink of the invention may also include thermal crosslinking compounds and other such additives besides the double bond compound (B) and the photopolymerization initiator (C).

3.1 Double Bond Compound (B)

There are no particular restrictions on the double bond compound (B) included in the inkjet ink of the invention as long as it is a compound that has one or more double bond, but it is preferable to use a compound that has a (meth)acryloyl group because the cured film of the inkjet ink of the invention will have higher chemical resistance.

Specific examples of compounds having a (meth)acryloyl group include compounds expressed by the above-mentioned Formula (2), 3-methyl-3-(meth)acryloxymethyloxetane, 3-ethyl-3-(meth)acryloxymethyloxetane, 3-methyl-3-(meth)acryloxyethyloxetane, 3-ethyl-3-(meth)acryloxyethyloxetane, 2-methyl-2-(meth)acryloxymethyloxetane, 2-ethyl-2-(meth)acryloxymethyloxetane, 2-methyl-2-(meth)acryloxyethyloxetane, 2-ethyl-2-(meth)acryloxyethyloxetane, (meth)acrylic acid, mono(2-methacryloyloxyethyl)maleate, mono(2-methacryloyloxyethyl)fumarate, mono(2-methacryloyloxyethyl) cyclohexene-3,4-dicarboxylate, α-chloroacrylic acid, ω-carboxypolycaprolactone mono(meth)acrylate, mono(2-acryloyloxyethyl)succinate, (meth)acrylamide, tricyclo[5.2.1.0^{2,6}]decanyl(meth)acrylate, tricyclodecanedimethanol diacrylate, dicyclopentenyl(meth)acrylate, dicyclopentenyloxyethyl(meth)acrylate, benzyl(meth)acrylate, isobornyl(meth)acrylate, methyl(meth)acrylate, cyclohexyl(meth)acrylate, glycidyl(meth)acrylate, butyl(meth)acrylate, 2-hydroxyethyl(meth)acrylate, 2-hydroxypropyl(meth)acrylate, phenyl(meth)acrylate, glycerol mono(meth)acrylate, polystyrene macromonomer, polymethyl methacrylate macro monomer, 4-hydroxybutyl(meth)acrylate, 4-hydroxybutyl(meth)acrylate glycidyl ether, 1,4-cyclohexane dimethanolmono(meth)acrylate, a (meth)acrylate of a caprolactone-modified tetrahydrofurfuryl alcohol, ethylene glycol di(meth)acrylate, diethylene glycol di(meth)acrylate, triethylene glycol di(meth)acrylate, tetraethylene glycol di(meth)acrylate, polyethylene glycol di(meth)acrylate, epichlorohydrin-modified ethylene glycol di(meth)acrylate, epichlorohydrin-modified diethylene glycol di(meth)acrylate, epichlorohydrin-modified triethylene glycol di(meth)acrylate, epichlorohydrin-modified tetraethylene glycol di(meth)acrylate, epichlorohydrin-modified polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, epichlorohydrin-modified propylene glycol di(meth)acrylate, epichlorohydrin-modified dipropylene glycol di(meth)acrylate, epichlorohydrin-modified tripropylene glycol di(meth)acrylate, epichlorohydrin-modified tetrapropylene glycol di(meth)acrylate, epichlorohydrin-modified polypropylene glycol di(meth)acrylate, trimethylolpropane tri(meth)acrylate, ethylene oxide-modified trimethylolpropane tri(meth)acrylate, propylene oxide-modified trimethylolpropane tri(meth)acrylate, epichlorohydrin-modified trimethylolpropane tri(meth)acrylate, ditrimethylolpropane tetra(meth)acrylate, glycerol acrylate methacrylate, glycerol di(meth)acrylate, glycerol tri(meth)acrylate, epichlorohydrin-modified glycerol tri(meth)acrylate, 1,6-hexanediol di(meth)acrylate, epichlorohydrin-modified 1,6-hexanediol di(meth)acrylate, methoxified cyclohexyl di(meth)acrylate, neopentyl glycol di(meth)acrylate, hydroxypivalic acid neopentyl glycol di(meth)acrylate, caprolactone-modified hydroxypivalic acid neopentyl glycol di(meth)acrylate, diglycerol tetra(meth)acrylate, pentaerythritol tri(meth)acrylate, pentaerythritol tetra(meth)acrylate, stearic acid-modified pentaerythritol di(meth)acrylate, dipentaerythritol penta(meth)acrylate, alkyl-modified dipentaerythritol penta(meth)acrylate, alkyl-modified dipentaerythritol tetra(meth)acrylate, alkyl-modified dipentaerythritol tri(meth)acrylate, dipentaerythritol hexa(meth)acrylate, caprolactone-modified dipentaerythritol hexa(meth)acrylate, allylated cyclohexyl di(meth)acrylate, bis[(meth)acryloxyneopentylglycol]adipate, 2,2-bis[4-((meth)acryloxy)phenyl]propane, 2,2-bis[4-((meth)acryloxypolyethoxy)phenyl]propane, 2,2-bis[4-((meth)acryloxy)phenyl]methane, 2,2-bis[4-((meth)acryloxypolyethoxy)phenyl]methane, 2,2-bis[4-((meth)acryloxy)phenyl]sulfone, 2,2-bis[4-((meth)acryloxypolyethoxy)phenyl]sulfone, 1,4-butanediol di(meth)acrylate, 1,3-butylene glycol(meth)acrylate, dicyclopentanyl di(meth)acrylate, ethylene oxide-modified phosphoric acid di(meth)acrylate, ethylene oxide-modified phosphoric acid tri(meth)acrylate, ethylene oxide-modified phosphoric acid di(meth)acrylate, ethylene oxide-modified phosphoric acid tri(meth)acrylate, epichlorohydrin-modified phthalic acid di(meth)acrylate, tetrabromobisphenol A di(meth)acrylate, triglycerol di(meth)acrylate, neopentyl glycerol-modified trimethylolpropane di(meth)acrylate, tris[(meth)acryloxyethyl]isocyanurate, caprolactone-modified tris[(meth)acryloxyethyl]isocyanurate, (meth)acrylated isocyanurate, isocyanuric acid ethylene oxide-modified di(meth)acrylate, urethane(meth)acrylate, and the like.

Many urethane(meth)acrylates are commercially available, such as product name “NK Oligo UA-W2A,” “NK Oligo U-2PPA,” “NK Oligo U-4HA,” “NK Oligo U-6HA,” “NK Oligo U-6LPA,” “NK Oligo U-15HA,” “NK Oligo UA-32P,” “NK Oligo 324A” (manufactured by Shin-Nakamura Chemical Co., Ltd) and the like.

Of these specific examples, compounds that have an oxirane, oxetane, hydroxy, or other such thermal crosslinking functional group are preferred. More specifically, it is particularly favorable to use glycidyl(meth)acrylate, 2-hydroxyethyl(meth)acrylate, 2-hydroxypropyl(meth)acrylate, 4-hydroxybutyl(meth)acrylate, 4-hydroxybutyl(meth)acrylate glycidyl ether, 1,4-cyclohexanedimethanol mono(meth)acrylate, 3-ethyl-3-(meth)acryloxy methyloxetane, 2-ethyl-2-(meth)acryloxymethyloxetane, pentaerythritol tri(meth)acrylate, dipentaerythritol penta(meth)acrylate, or isocyanuric acid ethylene oxide-modified di(meth)acrylate.

The double bond compound (B) may be a single type of compound, or may be a mixture of two or more different kinds of compound.

The double bond compound (B) is preferably used in an amount of approximately 20 to approximately 1,000 weight parts, and more preferably approximately 30 to approximately 500 weight parts, per 100 weight parts of the compound (A) because the cured film obtained with the inkjet ink of the invention will have higher chemical resistance.

3.2 Photopolymerization Initiator (C)

There are no particular restrictions on the photopolymerization initiator (C) included in the inkjet ink of the invention as long as it has the property of generating radicals when irradiated with ultraviolet or visible light rays.

Specific examples of the photopolymerization initiator (C) include benzophenone, Michler's ketone, 4,4′-bis(diethylamino)benzophenone, xanthone, thioxanthone, isopropylxanthone, 2,4-diethylthioxanthone, 2-ethylanthroquinone, acetophenone, 2-hydroxy-2-methylpropiophenone, 2-hydroxy-2-methyl-4′-isopropylpropiophenone, 1-hydroxycyclohexyl phenyl ketone, isopropyl benzoin ether, isobutyl benzoin ether, 2,2-diethoxyacetophenone, 2,2-dimethoxy-2-phenylacetophenone, camphorquinone, benzanthrone, 2-methyl-1-[4-(methylthio)phenyl]-2-morpholinopropan-1-one, ethyl 2-benzyl-2-dimethylamino-1-(4-morpholinophenyl)-butanone-1,4-dimethylaminobenzoate, isoamyl4-dimethylaminobenzoate, 4,4′-di(t-butylperoxycarbonyl)benzophenone, 3,4,4′-tri(t-butylperoxycarbonyl)benzophenone, 2,4,6,-trimethylbenzoyldiphenylphosphine oxide, 2-(4′-methoxystyryl)-4,6- bis(trichloromethyl)-s-triazine, 2-(3′,4′-dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)-4,6-bis(trichloromethyl)-s-triazine, 2-(4′-pentyloxystyryl)-4,6- bis(trichloromethyl)-s-triazine, 4-[p-N,N-di(ethoxycarbonylmethyl)]-2,6- di(trichloromethyl)-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-dimethylaminostyryl)benzoxazole, 2-(p-dimethylaminostyryl)benzthiazole, 2-mercaptobenzothiazole, 3,3′-carbonylbis(7-diethylaminocoumarin), 2-(o-chlorophenyl)-4,4′,5,5′-tetraphenyl-1,2′-biimidazole, 2,2′-bis(2-chlorophenyl)-4,4′,5,5′-tetrakis(4-ethoxycarbonylphenyl)-1,2′-biimidazole, 2,2′-bis(2,4-dichlorohenyl)-4,4′5,5′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 3-(2-dimethylaminopropionyl)carbazole, 3,6-bis(2-methyl-2-morpholinopropionyl)-9-n-dodecylcarbazole, 1-hydroxycyclohexyl phenyl ketone, bis(η⁵-2,4-cyclopentadien-1-yl)-bis(2,6-difluoro-3-(1H-pyrrol-1-yl)-phenyl)titanium, 2-methyl-1-[4-(methylthio)phenyl]-2-morpholinopropan-1-one, 2-benzyl-2-dimethylamino-1-(4-morpholinophenyl)-butanone-1, compounds expressed by the above-mentioned Formula (6), compounds expressed by the above-mentioned Formula (7), and the like.

Specific examples of compounds expressed by Formula (6) include 3,3′,4,4′-tetra(t-butylperoxycarbonyl)benzophenone, 3,3′,4,4′-tetra(t-hexylperoxycarbonyl)benzophenone, 3,3′-di(methoxycarbonyl)-4,4′-di(t-butylperoxycarbonyl)benzophenone, 3,4′-di(methoxycarbonyl)-4,3′-di(t-butylperoxycarbonyl)benzophenone, and 4,4′-di(methoxycarbonyl)-3,3′-di(t-butylperoxycarbonyl)benzophenone. Specific examples of compounds expressed by Formula (7) include 1,2-octanedione, 1-[4-(phenylthio)phenyl]-2-(o-benzoyloxime), and the like.

Of these, the photopolymerization initiator (C) is preferably one or more compounds selected from the group of compounds expressed by Formula (6), compounds expressed by Formula (7), 2-methyl-1-[4-(methylthio)phenyl]-2-morpholinopropan-1-one, and 2-benzyl-2-dimethylamino-1-(4-morpholinophenyl)-butanone-1.

The photopolymerization initiator (C) may be a single type of compound, or may be a mixture of two or more different kinds of compound.

The photopolymerization initiator (C) is preferably contained in an amount of at least approximately 20 wt % with respect to the weight of the inkjet ink of the invention because the resulting ink will have higher sensitivity.

3.3 Thermal Crosslinking Compound

Examples of thermal crosslinking compounds that may be included in the inkjet ink of the invention include epoxy resins, melamine compounds, bisazide compounds, polymers of radical polymerizable monomers having a thermal crosslinking functional group, copolymers of radical polymerizable monomers having a thermal crosslinking functional group with other radical polymerizable monomer, and the like. Of these, the use of an epoxy resin is preferred.

There are no particular restrictions on the epoxy resin as long as it has one or more oxirane, but a compound having two or more oxiranes is preferable.

Specific examples of epoxy resins include polymers of monomers having one or more oxirane, and copolymers of monomers having one or more oxirane with other monomers.

Specific examples of monomers having one or more oxirane include glycidyl(meth)acrylate, methyl glycidyl(meth)acrylate, and 3,4-epoxycyclohexyl(meth)acrylate.

Specific examples of other monomers that can be copolymerized with a monomer having an oxirane include (meth)acrylic acid, methyl(meth)acrylate, ethyl(meth)acrylate, isopropyl(meth)acrylate, butyl(meth)acrylate, iso-butyl(meth)acrylate, t-butyl(meth)acrylate, cyclohexyl(meth)acrylate, benzyl(meth)acrylate, 2-hydroxyethyl(meth)acrylate, 2-hydroxy propyl(meth)acrylate, styrene, methylstyrene, chloromethylstyrene, N-cyclohexylmaleimide, and N-phenylmaleimide.

It is preferable to use a polyglycidyl methacrylate, a methyl methacrylate-glycidyl methacrylate copolymer, a benzyl methacrylate-glycidyl methacrylate copolymer, a butyl methacrylate-glycidyl methacrylate copolymer, a 2-hydroxyethyl methacrylate-glycidyl methacrylate copolymer, or a styrene-glycidyl methacrylate copolymer as the polymer of monomers having one or more oxirane, and the copolymer of monomers having one or more oxirane with other monomers because the chemical resistance of the coating film after the ink is cured will be higher.

Examples of the epoxy resin that can be included in the inkjet ink of the invention, other than the specific examples given above, include product name “Epikote 807,” “Epikote 815,” “Epikote 825,” “Epikote 827,” “Epikote 828,” “Epikote 190P,” and “Epikote 191P” (manufactured by Yuka-Shell Epoxy Co., Ltd.), “Epikote 1004” and “Epikote 1256” (trade manufactured by Japan Epoxy Resin Co., Ltd.), “Araldite CY177” and “Araldite CY184” (manufactured by Japan Ciba-Geigy Co., Ltd.), “Celoxide 2021P,” “Celoxide 3000,” and “EHPE-3150” (manufactured by Daicel Chemical Industries, Ltd.), “Techmore VG3101L” (manufactured by Mitsui Chemicals Inc.), N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, and the like. Of these epoxy resins, the use of “Epikote 828,” “Techmore VG3101,” “Celoxide 2021P,” or “Araldite CY184” is preferable because the chemical resistance of the coating film after the curing of the ink will be higher.

The inkjet ink of the invention preferably includes the above-mentioned thermal crosslinking resin in an amount of approximately 5 to approximately 500 weight parts, and more preferably approximately 10 to approximately 300 weight parts, per 100 weight parts compound (A) because a cured film of the resulting ink will have higher chemical resistance.

3.4 Solvent

Examples of the solvent that may be included in the inkjet ink of the invention include water, butyl acetate, butyl propionate, ethyl lactate, methyl oxyacetate, ethyl roxyacetate, butyl oxyacetate, methyl methoxyacetate, ethyl methoxyacetate, butyl methoxyacetate, methyl ethoxyacetate, ethyl ethoxyacetate, methyl 3-oxypropionate, ethyl 3-oxypropionate, methyl 3-methoxypropionate, ethyl 3-methoxypropionate, methyl 3-ethoxypropionate, ethyl 3-ethoxypropionate, methyl 2-oxypropionate, ethyl 2-oxypropionate, propyl 2-oxypropionate, methyl 2-methoxypropionate, ethyl 2-methoxypropionate, propyl 2-methoxypropionate, methyl 2-ethoxypropionate, ethyl 2-ethoxypropionate, methyl 2-oxy-2-methylpropionate, ethyl 2-oxy-2-methylpropionate, methyl 2-methoxy-2-methylpropionate, ethyl 2-ethoxy-2-methylpropionate, methyl pyruvate, ethyl pyruvate, propyl pyruvate, methyl aceto acetate, ethyl aceto acetate, methyl 2-oxobutanoate, ethyl 2-oxobutanoate, dioxane, ethylene glycol, diethylene glycol, triethylene glycol, propylene glycol, dipropylene glycol, tripropylene glycol, 1,4-butanediol, ethylene glycol monoisopropyl ether, ethylene glycol monobutyl ether, propylene glycol monomethyl ether, propylene glycol monomethyl ether acetate, propylene glycol monoethyl ether acetate, propylene glycol monopropyl ether acetate, dipropylene glycol monomethyl ether, dipropylene glycol monomethyl ether acetate, dipropylene glycol monoethyl ether acetate, dipropylene glycol monopropyl ether acetate, ethylene glycol monobutyl ether acetate, cyclohexanone, cyclopentanone, diethylene glycol monomethyl ether, diethylene glycol monomethyl ether acetate, diethylene glycol monoethyl ether, diethylene glycol monoethyl ether acetate, diethylene glycol monobutyl ether, diethylene glycol monobutyl ether acetate, diethylene glycol dimethyl ether, diethylene glycol diethyl ether, diethylene glycol methyl ethyl ether, toluene, xylene, y-butyrolactone, N,N-dimethylacetamide, N-methyl-2-pyrrolidone, dimethylimidazolidinone, and the like.

Of these solvents, it is preferable to use propylene glycol monomethyl ether, propylene glycol monomethyl ether acetate, propylene glycol monoethyl ether acetate, dipropylene glycol monomethyl ether acetate, methyl 3-methoxypropionate, ethyl 3-ethoxypropionate, diethylene glycol monoethyl ether acetate, diethylene glycol monobutyl ether acetate, diethylene glycol dimethyl ether, diethylene glycol methyl ethyl ether, ethyl lactate, butyl acetate, γ-butyrolactone, or dimethylimidazolidinone.

It is more preferable for the inkjet ink of the invention to include a solvent such that the components other than the solvent account for at least approximately 30% of the total, and even more preferably at least approximately 50%, because there will be less spreading of the ink upon landing.

3.5 Colorant

The photocurable inkjet ink of the invention can further include a colorant. Copper phthalocyanine or another such pigment can be used favorably as a colorant.

3.6 Other Additives

The inkjet ink of the invention can include additives other than those listed above, to improve resolution, coating uniformity, and adhesion. Examples of such additives include acrylic-, styrene-, polyethyleneimine-, and urethane-based macromolecular dispersants, anionic, cationic, nonionic, and fluorine-based surfactants, silicone resins and other such coating improvers, silane coupling agents and other such adhesion improvers, alkoxybenzophenones and other such UV absorbents, sodium polyacrylate and other such anticoagulants, and organic carboxylic acids and other such alkali solubility promoters.

Specific examples of additives that may be included in the inkjet ink of the invention include EFKA-745, EFKA-46, EFKA-47, EFKA-47EA, EFKA polymer 100, EFKA polymer 400, EFKA polymer 401, and EFKA polymer 450 (trade names of products made by Morishita & Co., Ltd.), Solsperse 3000, Solsperse 5000, Solsperse 9000, Solsperse 12000, Solsperse 13240, Soisperse 13940, Solsperse 17000, Solsperse 20000, Solsperse 24000, Solsperse 24000GR, Solsperse 26000, Solsperse 28000, and Solsperse 32000 (trade names of products made by The Lubrizol Corporation), Disperse Aid 6, Disperse Aid 8, Disperse Aid 15, and Disperse Aid 9100 (trade names of products made by San Nopco), Polyflo No. 75, Polyflo No. 90, and Polyflo No. 95 (trade names of products made by Kyoeisha Chemical Co., Ltd.), Disperbyk 161, Disperbyk 162, Disperbyk 163, Disperbyk 164, Disperbyk 166, Disperbyk 170, Disperbyk 180, Disperbyk 181, and Disperbyk 182 (trade names of products made by BYK-Chemie), fluoroalkylbenzenesulfonate, fluoroalkylcarboxylate, fluoroalkyl polyoxyethylene ether, fluoroalkyl ammonium iodide, fluoroalkyl betaine, fluoroalkyl sulfonate, diglycerin tetrakis(fluoroalkyl polyoxyethylene ether), fluoroalkyl trimethyl ammonium salt, fluoroalkylaminosulfonate, polyoxyethylene nonyl phenyl ether, polyoxyethylene octyl phenyl ether, polyoxyethylene alkyl ether, polyoxyethylene lauryl ether, polyoxyethylene oleyl ether, polyoxyethylene tridecyl ether, polyoxyethylene cetyl ether, polyoxyethylene stearyl ether, polyoxyethylene laurate, polyoxyethylene oleate, polyoxyethylene stearate, polyoxyethylene laurylamine, sorbitan laurate, sorbitan palmitate, sorbitan stearate, sorbitan oleate, sorbitan fatty acid ester, polyoxyethylene sorbitan laurate, polyoxyethylene sorbitan palmitate, polyoxyethylene sorbitan stearate, polyoxyethylene sorbitan oleate, polyoxyethylene naphthyl ether, alkylbenzene sulfonate, alkyl diphenyl ether disulfonate, product name “BYK 300,” “BYK 310,” “BYK 320,” “BYK 330,” and “BYK 346” (manufactured by BYK-Chemie), and product name “Polyflo No. 45” and “Polyflo KL-245” (manufactured by Kyoeisha Chemical Co., Ltd.).

These additives can be used singly or as mixtures of two or more types.

Of these additives, the use of compounds selected from among a fluoroalkylbenzenesulfonate, fluoroalkylcarbonate, fluoroalkyl polyoxyethylene ether, fluoroalkyl ammonium iodide, fluoroalkyl betaine, fluoroalkyl sulfonate, diglycerol tetrakis(fluoroalkyl polyoxyethylene ether), fluoroalkyl trimethyl ammonium salt, and fluoroalkylaminosulfonate is preferable because the discharge characteristics of the resulting inkjet ink will be better.

4. Coating with Inkjet Ink by Inkjet Method

The inkjet ink of the invention can be used in any inkjet coating method that includes a step of coating by a known inkjet method. Examples of inkjet coating methods include a method in which the ink is applied by exerting kinetic energy on the ink, and a method in which the ink is applied by exerting thermal energy on the ink.

Using an inkjet coating method allows the ink to be applied in a predetermined pattern. This allows the ink to be applied only where necessary, which lowers the cost.

An example of a coating unit that is favorable for coating with the ink pertaining to the invention is a unit equipped with an ink holder for holding the ink, and a coating head. The coating unit, for example, subjects the ink to thermal energy corresponding to a coating signal, and this energy produces ink droplets.

The coating head has, for example, a heat generating component, whose face that comes into contact with the ink contains a metal and/or a metal oxide. Specific examples of the above-mentioned metal and/or metal oxide include metals such as tantalum, zirconium, titanium, nickel, and aluminum, and oxides of these metals.

An example of a coating apparatus that is favorable for coating with the ink pertaining to the invention is one that imparts energy corresponding to a coating signal to the ink in the chamber of an ink holder in which the ink is held, and uses this energy to produce ink droplets.

The inkjet coating apparatus may be one in which the coating head and the ink holder are separate, or one in which these are inseparably integrated. Also, the ink holder may be mounted on a carriage and integrated separably or inseparably with respect to the coating head, or it may be provided to a fixed part of the apparatus, and the ink supplied to the coating head through an ink supply member, such as a tube.

5. Formation of Cured Film

The cured film of the invention can be obtained by using a known inkjet coating method to discharge the inkjet ink of the invention onto the surface of a board or other substrate, and then heating the coating or irradiating it with light.

When the cured film is obtained by heating, it is obtained, for example, by drying for approximately 1 to approximately 10 minutes at approximately 80 to approximately 150° C., and then heating for approximately 10 to approximately 100 minutes in an approximately 160 to approximately 240° C. oven.

When the cured film is obtained by irradiation with light, it is obtained, for example, by irradiation with visible light or the like. More specifically, the portion of the ink that is irradiated with light is cured through three-dimensional crosslinking by polymerization of the acrylic monomer, and this effectively reduces the spreading of the ink. Therefore, a very fine pattern can be drawn when the inkjet ink of the invention is used.

When ultraviolet rays are used as the irradiating light, the amount of irradiating ultraviolet rays is preferably about approximately 10 to approximately 500 mJ/cm² as i-rays.

The ink that has been applied to the surface of a substrate may be further heated as needed, and it is particularly favorable to heat it for approximately 10 to approximately 100 minutes at approximately 150 to approximately 220° C.

There are no particular restrictions on the substrate used with the invention, but examples include plastic films made of polyester-based resins such as polyethylene terephthalate (PET) or polybutylene terephthalate (PBT), polyolefin resins such as polyethylene or polypropylene, plastic film such as polyvinyl chloride, fluororesins, acrylic resins, polyamides, polycarbonates, polyimides, as well as cellophane, acetate, metal foil, glassine paper having a sealing effect, parchment paper, and paper subjected to a sealing treatment with polyethylene, a clay binder, polyvinyl alcohol, starch, carboxymethyl cellulose (CMC), or the like. Furthermore, the substance that makes up the substrate may further contain additives such as pigments, dyes, antioxidants, anti-degradation agents, fillers, ultraviolet absorbents, antistatic agents, and/or electromagnetic shielding agents, etc., as long as these do not adversely affect the effects of the invention.

There are no particular restrictions on the thickness of the substrate, and although it is usually about approximately 10 μm to approximately 2 mm and is suitably adjusted according to its intended use, the thickness is preferably approximately 15 to approximately 500 μm, and more preferably approximately 20 to approximately 200 μm.

The surface of the substrate on which the cured film is to be formed may be subjected as needed to an adhesion priming treatment, such as a corona treatment, a plasma treatment, or a blasting treatment, or an adhesion priming layer may be provided on that surface.

It will be apparent to those skilled in the art that various modifications and variations can be made in the invention and specific examples provided herein without departing from the spirit or scope of the invention. Thus, it is intended that the invention covers the modifications and variations of this invention that come within the scope of any claims and their equivalents.

The following examples are for illustrative purposes only and are not intended, nor should they be interpreted to, limit the scope of the invention.

### EXAMPLES

Although the invention will now be described further through working examples, the invention is not limited to these examples.

### Synthesis Example 1

### Synthesis of Compound (A-1)

The following compounds were put in a four-necked flask equipped with a stirrer, and heated for 3 hours at 120° C.

| | |
|---|---|
| 3,3′,4,4′-diphenyl ether tetracarboxylic dianhydride | 15.5 g |
| styrene-maleic anhydride copolymer | 7.1 g |
| (molar ratio 1:1, molecular weight 1500) | |
| 1,4-butanediol | 2.3 g |
| benzyl alcohol | 2.6 g |
| diethylene glycol methyl ethyl ether | 67.5 g |

The reaction solution was then cooled to 40° C., and the following compounds were added and stirred for 5 hours at 40° C.

| | |
|---|---|
| Silaplane FM-3311 (manufactured by Chisso) | 15.0 g |
| 3,3′-diaminodiphenylsulfone | 2.5 g |

The Silaplane FM-3311 here is a diamine having the structure of Formula (3), wherein R¹ and R² are both a methyl, R⁶ is a propylene, m is 1, and n is an integer from 10 to 20.

The reaction solution thus obtained was cooled to room temperature, which gave a 40 wt % diethylene glycol methyl ethyl ether solution of compound (A-1). The weight average molecular weight of the resulting compound (A-1) was 3,000 as found by GPC analysis.

To find the weight average molecular weight, the obtained polymer powder was diluted with tetrahydrofuran to a polymer concentration of approximately 1 wt %, and a JASCO GULLIVER 1500 (Intelligent Differential Refractometer RI-1530) made by JASCO was used as a developing agent to measure the average molecular weight by a GPC method, using a polystyrene standard. Four columns, namely, G4000HXL, G3000HXL, G2500HXL, and G2000HXL (all made by Tosoh), were connected in that order, and measurements were made at a column temperature of 40° C. and a flow rate of 1.0 mL/min.

### Synthesis Example 2

### Comparative Synthesis Example

The following compounds were put in a four-necked flask equipped with a stirrer, and heated for 6 hours at reflux temperature.

| | |
|---|---|
| 2-butanone | 150.0 g |
| benzyl methacrylate | 40.0 g |
| 2-hydroxyethyl methacrylate | 5.0 g |
| methacrylic acid | 5.0 g |
| dimethyl 2,2′-azobis(2-methylpropionate) | 2.0 g |

The reaction solution was then cooled to room temperature and poured into a large quantity of hexane. The cake of sediment thus produced was vacuum dried at 100 Pa and 40° C. for 20 hours, and the block thus obtained was pulverized and vacuum dried again under the same conditions, which gave 44.3 g of polymer powder. Just as in Synthesis Example 1, the weight average molecular weight of the resulting polymer was measured by GPC analysis and found to be 15,000.

### Example 1

The following components were mixed, dissolved, and filtered through a Teflon™ membrane filter with a pore size of 0.5 μm, and an inkjet ink was prepared as follows.

| | |
|---|---|
| 40 wt % solution of compound (A-1) | 10.0 g |
| epoxy resin (“Techmore VG3101L” product name | 0.5 g |
| of Mitsui Chemicals) | |
| propylene glycol monomethyl ether acetate | 5.0 g |

The viscosity of the obtained inkjet ink at 25° C. was 21 mPa·s.

Using this inkjet ink, and using a DMP-2800 inkjet coating apparatus made by Dimatix, straight lines of 5 cm were drawn on a polyimide substrate. The drawing conditions were set so that the width of the lines and the width between the lines would be the same. Drawing such as this will be referred to as “line and space coating” in this Specification. The coating was performed only once, the speed of jetting from the nozzle was 10 jets per second, the line width was 500 μm, and the jetting temperature was 30° C. After jetting, the substrate was dried for 5 minutes at 80° C., after which it was heated for 30 minutes in a 200° C. oven, which gave a cured film in the form of lines.

The line width and edge straightness of the cured film thus obtained were examined under an optical microscope, the results of which are given in Table 1. The line width remained substantially unchanged from the time of coating, and the edges of the lines had good straightness.

### Example 2

The following components were mixed, dissolved, and filtered through a Teflon™ membrane filter with a pore size of 0.5 μm, and a photocurable inkjet ink was prepared.

The compound (A-1) obtained in Synthesis Example 1 was used as the compound (A) of the invention, 4-hydroxybutyl acrylate and pentaerythritol tetraacrylate (product name “Aronics M450” manufactured by Toa Gosei) were used as the double bond compound (B), and 2-benzyl-2-dimethylamino-1-(4-morpholinophenyl)-butanone-1 (product name “IRGACURE 369” manufactured by Ciba Specialty Chemicals) was used as the photopolymerization initiator (C).

| | |
|---|---|
| 40 wt % solution of compound (A-1) | 10.0 g |
| 4-hydroxybutyl acrylate | 10.0 g |
| pentaerythritol tetraacrylate (“Aronics M450” | 3.0 g |
| manufactured by Toa Gosei) | |
| 2-benzyl-2-dimethylamino-1-(4-morpholinophenyl)- | 1.5 g |
| butanone-1 (“IRGACURE 369” manufactured by Ciba | |
| Specialty Chemicals) | |

The viscosity of the obtained inkjet ink at 25° C. was 69 mPa·s.

Using this photocurable inkjet ink, line and space coating was performed in the same manner as in Example 1. The jetting temperature was 65° C. After jetting, the substrate was irradiated with 40 mJ/cm of i-rays using a super-high-pressure mercury vapor lamp, after which it was heated for 30 minutes in a 160° C. oven, which gave a cured film in the form of lines.

The line width and edge straightness of the cured film thus obtained were examined under an optical microscope, the results of which are given in Table 1. The line width remained substantially unchanged from the time of coating, and the edges of the lines had good straightness.

### Comparative Example 1

The following components were mixed, dissolved, and filtered through a Teflon™ membrane filter with a pore size of 0.5 μm, and a photocurable inkjet ink was prepared.

| | |
|---|---|
| polymer of Synthesis Example 2 | 3.0 g |
| 4-hydroxybutyl acrylate | 10.0 g |
| Aronics M210 | 3.0 g |
| IRGACURE 369 | 1.0 g |

The viscosity of the obtained inkjet ink at 25° C. was 69 mPa·s.

Using this photocurable inkjet ink, line and space coating was performed in the same manner as in Working Example 1. The jetting temperature was 65° C. After jetting, the substrate was irradiated with 40 mJ/cm² of i-rays using a super-high-pressure mercury vapor lamp, after which it was heated for 30 minutes in a 160° C. oven, which gave a cured film in the form of lines.

The line width and edge straightness of the cured film thus obtained were examined under an optical microscope, the results of which are given in Table 1. The lines spread out wider than at the time of coating, and the edges of the lines were jagged.

TABLE 1

| | Line Width (μm) | Edge Straightness |
|---|---|---|
| Example 1 | 550 to 565 | Good |
| Example 2 | 520 to 530 | Good |
| Comparative Example 1 | 580 to 645 | Jagged |

### INDUSTRIAL APPLICABILITY

The inkjet ink of the invention can be used, for example, for etching resists or protective films used on electronic circuit boards, for liquid crystal display spacers or protective films thereof, for insulating films used on flexible wiring boards, and for electronic components in which these are used.

What is claimed is:

1. An inkjet ink, comprising a compound (A) having structural units expressed by Formulas (1) and (2): 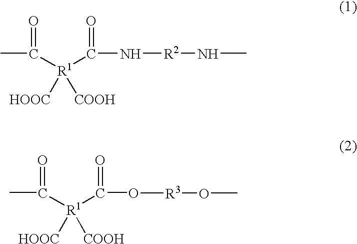
wherein Formulas (1) and (2), R¹, R², and R³ are each independently a C₂ to C₁₀₀ organic group.

2. The inkjet ink according to claim 1, wherein the compound (A) is synthesized using at least one acid anhydride group-containing compound (a1), an amino-containing compound (a2), and a hydroxy compound (a3).

3. The inkjet ink according to claim 2, wherein the at least one acid anhydride group-containing compound (a1) is a tetracarboxylic dianhydride.

4. The inkjet ink according to claim 2, wherein the at least one acid anhydride group-containing compound (a1) is a copolymer of a radical polymerizable monomer having an acid anhydride group and another radical polymerizable monomer.

5. The inkjet ink according to claim 2, wherein the at least one acid anhydride group-containing compound (a1) is one or more compounds selected from the group of styrene-maleic anhydride copolymers, methyl(meth)acrylate-maleic anhydride copolymers, glycidyl(meth)acrylate-maleic anhydride copolymers, 2-hydroxyethyl(meth)acrylate-maleic anhydride copolymers, styrene-itaconic anhydride copolymers, and methyl(meth)acrylate-itaconic anhydride copolymers.

6. The inkjet ink according to claim 2, wherein the amino-containing compound (a2) is one or more compounds selected from the group of 4,4′-diaminodiphenylsulfone, 3,3′-diaminodiphenylsulfone, 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]hexafluoropropane, 2,2′-diaminodiphenylpropane, and diamines expressed by Formula (3): 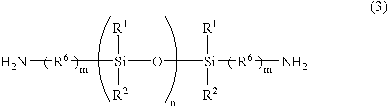
wherein Formula (3), R¹ and R² are each independently a C₁ to C₃ alkyl or phenyl, each R⁶ is independently a methylene, phenylene, or alkyl-substituted phenylene, each m is independently an integer from 1 to 6, and n is an integer from 1 to 100.

7. The inkjet ink according to claim 2, wherein the amino-containing compound (a2) is a diamine expressed by Formula (3): 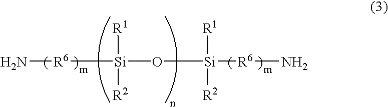
wherein Formula (3), R¹ and R² are each independently a C₁ to C₃ alkyl or phenyl, each R⁶ is independently a methylene, phenylene, or alkyl-substituted phenylene, each m is independently an integer from 1 to 6, and n is an integer from 1 to 100.

8. The inkjet ink according to claim 2, wherein the hydroxy compound (a3) is one or more compounds selected from the group of benzyl alcohol, propylene glycol monomethyl ether, diethylene glycol monomethyl ether, diethylene glycol monoethyl ether, cyclohexanol, ethylene glycol, diethylene glycol, triethylene glycol, polyethylene glycol with a degree of polymerization of 4 to 10, propylene glycol, dipropylene glycol, tripropylene glycol, polypropylene glycol with a degree of polymerization of 4 to 10, ethyl lactate, 1,4-butanediol, trimethylolpropane, pentaerythritol, dipentaerythritol, 1,2-butanediol, 1,4-cyclohexanedimethanol, an ethylene oxide adduct of 2,2-bis(4-hydroxyphenyl)propane, an ethylene oxide adduct of 2,2-bis(4-hydroxyphenyl)sulfone, and compounds expressed by Formula (4): 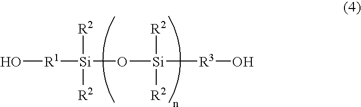
wherein Formula (4), R¹ and R³ are each independently a C₁ to C₂₀ alkyl in which any methylene may be replaced by an oxygen atom, R² is a C₁ to C₅ alkyl, and n is an integer from 1 to 100.

9. The inkjet ink according to claim 2, wherein the hydroxy compound (a3) is a compound obtained by reacting a compound having an oxirane with a compound having a carboxyl.

10. The inkjet ink according to claim 9, wherein the compound having a carboxyl is a (meth)acrylic acid.

11. The photocurable inkjet ink according to claim 1, further comprising a double bond compound (B) and a photopolymerization initiator (C).

12. The photocurable inkjet ink according to claim 11, wherein the double bond compound (B) has a (meth)acryloyl group.

13. The photocurable inkjet ink according to claim 11, wherein the double bond compound (B) has one or more groups selected from the group of oxirane, oxetane, and hydroxy.

14. The photocurable inkjet ink according to claim 11, wherein the double bond compound (B) is one or more compounds selected from the group of glycidyl (meth)acrylate, 2-hydroxyethyl(meth)acrylate, 2-hydroxypropyl(meth)acrylate, 4-hydroxybutyl(meth)acrylate, 4-hydroxybutyl(meth)acrylate glycidyl ether, 1,4-cyclohexanedimethanol mono(meth)acrylate, 3-ethyl-3-(meth)acryloxymethyloxetane, 2-ethyl-2-(meth)acryloxymethyloxetane, pentaerythritol tri(meth)acrylate, dipentaerythritol penta(meth)acrylate, and isocyanuric acid ethylene oxide-modified di(meth)acrylate.

15. The photocurable inkjet ink according to claim 11, wherein the photopolymerization initiator (C) is one or more compounds selected from the group of compounds expressed by the following Formula (6): 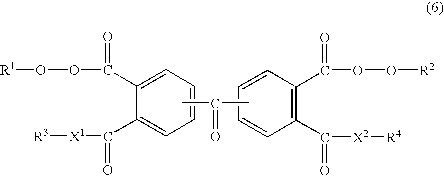
wherein Formula (6), R¹, R², R³ and R⁴ are each independently a C₁ to C₁₃ alkyl, and X¹ and X² are each independently a —O—, —O—O—, or —NH—, compounds expressed by the following Formula (7): 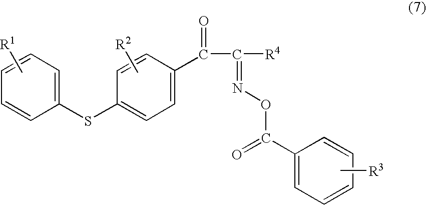
wherein Formula (7), R¹, R², and R³ are each independently a hydrogen or a C₁ to C₅ alkyl, and R⁴ is a C₁ to C₁₅ alkyl), 2-methyl-1-[4-(methylthio)phenyl]-2-morpholinopropan-1-one, and 2-benzyl-2-dimethylamino-1-(4-morpholinophenyl)-butanone-1.

16. The photocurable inkjet ink according to claim 11, wherein the photopolymerization initiator (C) contains one or more compounds selected from the group of compounds expressed by the following Formula (6): 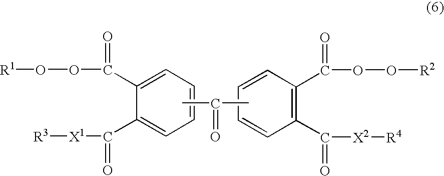
wherein Formula (6), R¹, R², R³ and R⁴ are each independently a C₁ to C₁₃ alkyl, and X¹ and X² are each independently a —O—, —O—O—, or —NH—, compounds expressed by the following Formula (7): 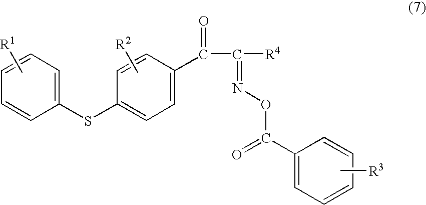
wherein Formula (7), R¹, R², and R³ are each independently a hydrogen or a C₁ to C₅ alkyl, and R⁴ is a C₁ to C₁₅ alkyl), 2-methyl-1-[4-(methylthio)phenyl]-2-morpholinopropan-1-one, and 2-benzyl-2-dimethylamino-1-(4-morpholinophenyl)-butanone-1 in an amount of 20 to 100% with respect to the total weight of the photopolymerization initiator (C).

17. The photocurable inkjet ink according to claim 11, wherein the inkjet ink comprises approximately 20 to approximately 1,000 weight parts of the double bond compound (B) and approximately 0.5 to approximately 200 weight parts of the photopolymerization initiator (C) per 100 weight parts compound (A).

18. A method for manufacturing an inkjet ink, comprising a step of manufacturing a compound (A) by polymerizing:
an acid anhydride group-containing compound (a1) that is one or more compounds selected from the group of styrene-maleic anhydride copolymers, methyl(meth)acrylate-maleic anhydride copolymers, glycidyl(meth)acrylate-maleic anhydride copolymers, 2-hydroxyethyl(meth)acrylate-maleic anhydride copolymers, styrene-itaconic anhydride copolymers, and methyl(meth)acrylate-itaconic anhydride copolymers,
an amino-containing compound (a2) that is one or more compounds selected from the group of 4,4′-diaminodiphenylsulfone, 3,3′-diaminodiphenylsulfone, 4,4′-diaminodiphenylmethane, 3,3′-diaminodiphenylmethane, 3,3′-dimethyl-4,4′-diaminodiphenylmethane, 2,2-bis[4-(4-aminophenoxy)phenyl]hexafluoropropane, 2,2′-diaminodiphenylpropane, and diamines expressed by the following Formula (3): 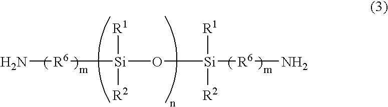
wherein Formula (3), R¹ and R² are each independently a C₁ to C₃ alkyl or phenyl, each R⁶ is independently a methylene, phenylene, or alkyl-substituted phenylene, each m is independently an integer from 1 to 6, and n is an integer from 1 to 100, and
a hydroxy compound (a3) that is one or more compounds selected from the group of ethylene glycol, propylene glycol, 1,4-butanediol, benzyl alcohol, diethylene glycol monoethyl ether, and compounds expressed by the following General Formula (4): 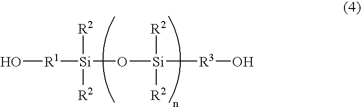
wherein Formula (4), R¹ and R³ are each independently a C₁ to C₂₀ alkyl in which any methylene may be replaced by an oxygen atom, R² is a C₁ to C₅ alkyl, and n is an integer from 1 to 100.

19. The method for manufacturing an inkjet ink according to claim 18, further comprising a step of mixing the compound (A) with a double bond compound (B) that is one or more compounds selected from the group of glycidyl(meth)acrylate, 2-hydroxyethyl(meth)acrylate, 2-hydroxypropyl(meth)acrylate, 4-hydroxybutyl(meth)acrylate, 4-hydroxybutyl(meth)acrylate glycidyl ether, 1,4-cyclohexanedimethanol mono(meth)acrylate, 3-ethyl-3-(meth)acryloxymethyloxetane, 2-ethyl-2-(meth)acryloxymethyloxetane, pentaerythritol tri(meth)acrylate, dipentaerythritol penta(meth)acrylate, and isocyanuric acid ethylene oxide-modified di(meth)acrylate, and
a photopolymerization initiator (C) that is one or more compounds selected from the group of 2-methyl-1-[4-(methylthio)phenyl]-2-morpholinopropan-1-one and 2-benzyl-2-dimethylamino-1-(4-morpholinophenyl)-butanone-1.

20. An ink coating method, comprising the steps of (i) applying the inkjet ink according to claim 1 by an inkjet coating method and then drying to form a coating film; and (ii) forming a cured film by heating this coating film or irradiating it with light.

21. A method for forming a cured film, wherein a cured film is formed using the inkjet coating method according to claim 20.

22. An electronic circuit board, wherein a cured film is formed on a board using the method for forming a cured film according to claim 21.

23. An electronic component, having the electronic circuit board according to claim 22.

24. An electronic circuit board and display element having the cured film formed in claim 21.

25. An ink coating method, comprising the steps of (i) applying the inkjet ink manufactured by the manufacturing method according to claim 18 by an inkjet coating method and then drying to form a coating film; and (ii) forming a cured film by heating this coating film or irradiating it with light.
